(19) United States
(12) Patent Application Publication
(10) Pub. No.: US 2011/0119207 A1
(43) Pub. Date: May 19, 2011

(54) Healthcare Index

(75) Inventors: T. C. Tong, Bloomington, MN (US); Jean W. Rawlings, Roy, UT (US); Christopher A. Hane, Irvine, CA (US); Ron Hoffner, Minneapolis, MN (US); David R. Anderson, Chaska, MN (US)

(73) Assignee: INGENIX, INC., Eden Prairie, MN (US)

(21) Appl. No.: 12/947,051

(22) Filed: Nov. 16, 2010

Related U.S. Application Data
(60) Provisional application No. 61/261,646, filed on Nov. 16, 2009.

(51) Int. Cl. G06Q 50/00

(52) U.S. Cl. 705/400

(57) ABSTRACT

System and methods for processing price data for health services are provided. In one embodiment, the system includes a data storage device configured to store a database comprising one or more records. The system may also include a server in data communication with the data storage device. The server may be suitably programmed to search the database to obtain a group of records of prices for a health service received by a group of subjects, wherein the health service is comprised in a service category; extract a representative price for the health service; determine a weight for the health service relative to the service category; and generate, using a processor, a weighted price for the health service based on the weight and the representative price.

### CROSS-REFERENCE TO RELATED APPLICATIONS

This application claims priority to U.S. Provisional Application No. 61/261,646 filed Nov. 16, 2009, the entire contents of which is specifically incorporated herein by reference without disclaimer.

### BACKGROUND OF THE INVENTION

1. Field of the Invention

This invention relates to health related data analysis and more particularly relates to a system and method for processing price data for health services.

2. Description of the Related Art

Most corporations, including health insurance corporations, maintain a high volume of data. Such data may be analyzed and exploited for valuable information regarding business trends, and other important statistics. Data mining is a common strategy for identifying and analyzing such data. There are many various forms of data mining. Custom analytic operations may be developed to meet specific needs. Alternatively, commercially available statistical analysis tools, such as Statistical Analysis Software (SAS) may be used to identify statistical trends in data.

Health insurance companies typically maintain databases of health insurance claim information, geographic information, demographic information, and other data about health insurance plan members. Such information may be used to gain valuable insights into early disease diagnosis, relationship between lab tests and diseases or drug treatments, and disease severity. Unfortunately, typical methods for analyzing such data are often cumbersome, pricey, and require unworkably high processing times and resources.

The referenced shortcomings are not intended to be exhaustive, but rather are among many that tend to impair the effectiveness of previously known techniques in disease management, diagnosis and treatment; however, those mentioned here are sufficient to demonstrate that the methodologies appearing in the art have not been satisfactory and that a significant need exists for the techniques described and claimed in this disclosure.

### SUMMARY OF THE INVENTION

From the foregoing discussion, it should be apparent that a need exists for a system and method to provide a representative price or index of health care.

A system is presented for processing price data for health services. In one embodiment, the system includes a data storage device configured to store a database comprising one or more records. The system may also include a server in data communication with the data storage device. The server may be suitably programmed to search the database to obtain a group of records of prices for a service (e.g., a health service) received by a group of subjects, wherein the service is comprised in a service category; extract a representative price for the health service; determine a weight for the health service relative to the service category; and generate, using a processor, a weighted price for the health service based on the weight and the representative price.

In one embodiment, the server may identify the group of subjects by one or more attributes, for example, a medical condition, a demographic feature, a geographical feature, or a combination thereof, such as age, sex, disease status, or location. In a further embodiment, the server may select the health service by predetermined criteria. For example, the selected health service is a procedure, a prescription drug, a lab test, or a combination thereof.

In a certain embodiment, the server may extract the representative price for a determined time frame. In another embodiment, the server may calculate the weight of the health service as the ratio of the total prices for the service to the total prices for the service category.

The server may further derive an elementary index representing a price of the service category from weighted prices of a plurality of medical devices. In a particular embodiment, the server may further process the elementary index to represent a price change relative to a baseline time.

For example, a group of subjects diagnosed with diabetes may be chosen. Specific services related to diabetes may be selected, by cohort matching, expert panel or suggested treatments, such as best practices for diabetes, or evidence-based solution. A database of claims may be searched for one of the selected services, such as a related CPT code, wherein the service code is received by diabetic patients. Total prices for that code may be calculated from the claims and the weight of the code relative to all the services relevant to diabetic patients could be calculated by dividing the total prices for that code by the total prices for all the diabetic services. A weighed price for that code may be calculated by the product of the weight and the current average price of the code.

In a further embodiment, the server may be used to generate aggregation indices of a upper level. In one embodiment, the server may further determine index weights and elementary indices for each of a plurality of service categories, wherein the plurality of service categories are comprised in an upper level service category; and generate, using a processor, an aggregation index based on the index weights and the elementary indices, wherein the aggregation index represents a price of the upper level service category. In another embodiment, the server may further determine index weights and elementary indices for each of a plurality of subject groups, wherein the plurality of service categories are comprised in an upper level subject category; and generate, using a processor, an aggregation index based on the index weights and the elementary indices, wherein the aggregation indices represent a price of the upper level subject category.

A method is also presented for processing price data for health services. In one embodiment, the method includes: searching a database stored on a data storage device to obtain a group of records of prices for a service (e.g., a health service) received by a group of subjects, wherein the service is comprised in a service category; extracting a representative price for the health service; determining a weight for the health service relative to the service category; and generating, using a processor, a weighted price for the health service based on the weight and the representative price. The method in the disclosed embodiments substantially includes the steps necessary to carry out the functions presented above with respect to the operation of the system of the present invention.

In one embodiment, the method may comprise identifying the group of subjects by one or more attributes, for example, a medical condition, a demographic feature, a geographical feature, or a combination thereof. In a further embodiment, the method may comprise selecting the health service by predetermined criteria. For example, the selected health service is a procedure, a prescription drug, a lab test, or a combination thereof.

In a certain embodiment, the method may comprise extracting the representative price for a determined time frame. In another embodiment, the method may comprise calculating the weight of the health service as the ratio of the total prices for the service to the total prices for the service category.

The method may comprise deriving an elementary index representing a price of the service category from weighted prices of a plurality of medical devices. In a particular embodiment, the method may further process the elementary index to represent a price change relative to a baseline time.

In a further embodiment, the method may be used to generate aggregation indices of a upper level. In one embodiment, the method may further determine index weights and elementary indices for each of a plurality of service categories, wherein the plurality of service categories are comprised in an upper level service category; and generate, using a processor, an aggregation index based on the index weights and the elementary indices, wherein the aggregation index represents a price of the upper level service category. In another embodiment, the method may further determine index weights and elementary indices for each of a plurality of subject groups, wherein the plurality of service categories are comprised in an upper level subject category; and generate, using a processor, an aggregation index based on the index weights and the elementary indices, wherein the aggregation indices represent a price of the upper level subject category.

There may be also provided a tangible computer program product comprising a computer readable medium having computer usable program code executable to perform operations comprising: searching a database stored on a data storage device to obtain a group of records of prices for a service (e.g., a health service) received by a group of subjects, wherein the service is comprised in a service category; extracting a representative price for the health service; determining a weight for the health service relative to the service category; and generating, using a processor, a weighted price for the health service based on the weight and the representative price.

In one embodiment, the server may include identifying the group of subjects by one or more attributes, for example, a medical condition, a demographic feature, a geographical feature, or a combination thereof. In a further embodiment, the server may include selecting the health service by predetermined criteria. For example, the selected health service is a procedure, a prescription drug, a lab test, or a combination thereof.

In a certain embodiment, the server may include extracting the representative price for a determined time frame. In another embodiment, the server may include calculating the weight of the health service as the ratio of the total prices for the service to the total prices for the service category.

The server may include deriving an elementary index representing a price of the service category from weighted prices of a plurality of medical devices. In a particular embodiment, the server may further process the elementary index to represent a price change relative to a baseline time.

In a further embodiment, the server may be used to generate aggregation indices of a upper level. In one embodiment, the server may further determine index weights and elementary indices for each of a plurality of service categories, wherein the plurality of service categories are comprised in an upper level service category; and generate, using a processor, an aggregation index based on the index weights and the elementary indices, wherein the aggregation index represents a price of the upper level service category. In another embodiment, the server may further determine index weights and elementary indices for each of a plurality of subject groups, wherein the plurality of service categories are comprised in an upper level subject category; and generate, using a processor, an aggregation index based on the index weights and the elementary indices, wherein the aggregation indices represent a price of the upper level subject category.

For a temporal analysis, the operations may further comprise selecting the group of records from within a predetermined time frame.

The term “associated” is referred to as connected or related. The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for processing price data for health services;

FIG. 2 is a schematic block diagram illustrating one embodiment of a database system for processing price data for health services;

FIG. 3 is a schematic block diagram illustrating one embodiment of a computer system that may be used in accordance with certain embodiments of the system for processing price data for health services;

FIG. 4 is a schematic logical diagram illustrating one embodiment of abstraction layers of operation in a system for processing price data for health services;

FIG. 5 is a schematic block diagram illustrating one embodiment of a system for processing price data for health services;

FIG. 6 is a schematic block diagram illustrating one embodiment of a system for processing price data for health services;

FIG. 7 is a schematic flowchart diagram illustrating one embodiment of a method for processing price data for health services;

FIG. 8 is a schematic flowchart diagram illustrating one embodiment of a method for processing price data for health services;

FIG. 9 is a schematic flowchart diagram illustrating one embodiment of a method for processing price data for health services;

FIG. 10 is a schematic block diagram illustrating one embodiment of a method for processing price data for health services.

### DETAILED DESCRIPTION

The present invention discloses methods, systems and program products related to a measure of the price of a set of health services, e.g., Ingenix Health Index. The purpose and scope of Ingenix Health Index could be similar to the U.S. Government's Bureau of Labor Statistics Consumer Price Index (CPI) (Consumer Price Index) and the CMS's National Health Expenditures (NHE). The Ingenix Health Index may provide a time-neutral index of the price of health care. This index could be useful to adjust real expenses over time into constant dollars. In certain aspects, it improves on the medical components of the CPI by being more specific to regions (CPI does not publish regional medical category values) and specific to co-morbidities (completely absent in the CPI).

The goal of the CPI is to answer the question, “What is the price, at this month's market prices, of achieving the standard of living actually attained in the base period?” (BLS, Handbook of Methods, Chapter 17, page 2, world wide web via bls.gov/opub/hom/pdf/homch17.pdf)

The Ingenix Health Index may seek to answer the question, “What is the price at this quarter's market prices of achieving the level of health services actually attained in the base period?” The goal may be to create a representative set of services that mirrors the entire market for health care services, and then follow the price of this set of services over time. The set of services could be adjusted over time as well for changes in availability of services.

Current methods to equalize prices over time, like the CPI or Federal inflation estimates, are not specific to health care. While the CPI provides indices for 12 components of medical prices, CPI provides a single estimate for these price components averaged over all US cities. It does not provide indices for populations with specific medical conditions or other attributes.

In understanding the price and utilization of health services, such as using an Employer Web (a web-based, subscription service), there still remains a need for benchmarking that includes: timely updates, coverage by region and industry, condition specificity for condition management programs, type of plan and plan design parameters.

In certain aspects of the invention, the Ingenix Health Index could be stratified to provide indices for various medically significant populations and to address the above issues in benchmarking.

Various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system.” Alan Freedman, “The Computer Glossary” 268 (8th ed. 1998). A module comprises a component of a machine, a machine or a plurality of machines that are suitably programmed to operate according to executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, a controller, or the like.

Modules may also include software-defined units or instructions that, when executed by a processing machine or device, retrieve and transform data stored on a data storage device from a first state to a second state. An identified module of executable code may, for instance, comprise one or more physical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

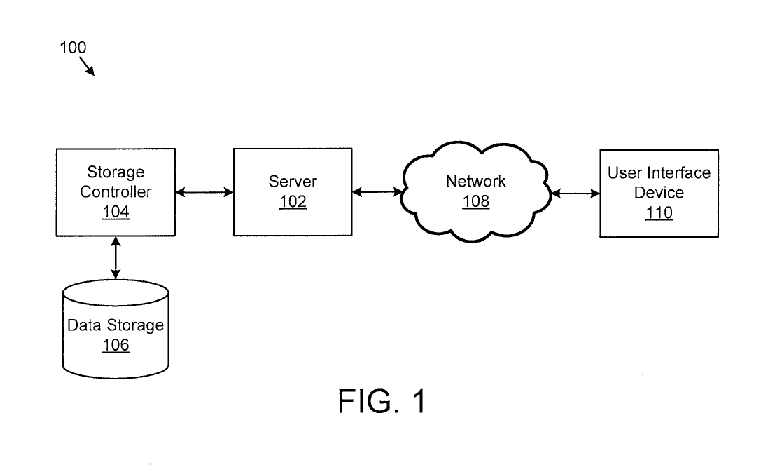

FIG. 1 illustrates one embodiment of a system 100 for processing price data for health services. The system 100 may include a server 102, a data storage device 106, a network 108, and a user interface device 110. In a further embodiment, the system 100 may include a storage controller 104, or storage server, configured to manage data communications between the data storage device 106, and the server 102 or other components in communication with the network 108. In an alternative embodiment, the storage controller 104 may be coupled to the network 108. In a general embodiment, the system 100 may store databases comprising records, perform searches of those records, and generate outputs in response to information contained in these records. Specifically, the system 100 may search a database for a group of records of prices and generate a weighted price, an elementary index, or an aggregation index.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, the user may enter predetermined criteria for selection of services, attributes for identifying subjects, a predetermined time frame, or a baseline time for generating an output, such as a weighted price or a price index, or the like.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is suitably programmed to search the database to obtain a group of records of prices for a health service received by a group of subjects, wherein the health service is comprised in a service category, extract a representative price for the health service, determine a weight for the health service relative to the service category, and generate, using a processor, a weighted price based on the weight and the representative price. Additionally, the server may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, a tape storage drive comprising a magnetic tape data storage device, an optical storage device, or the like. In one embodiment, the data storage device 106 may store health related data, such as insurance claims data, consumer data, or the like. The data may be arranged in a database and accessible through Structured Query Language (SQL) queries, or other data base query languages or operations.

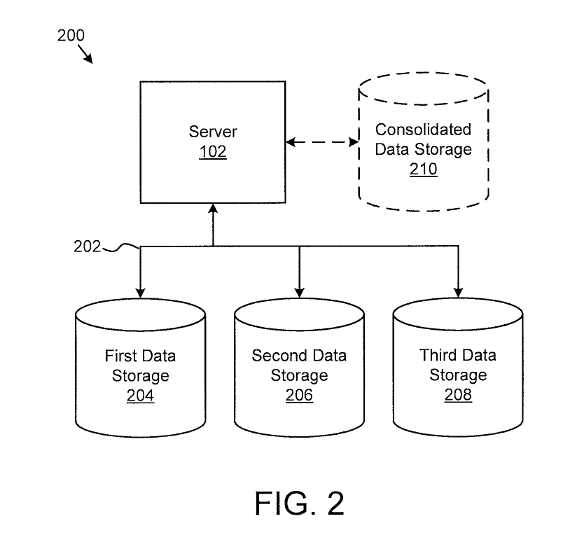

FIG. 2 illustrates one embodiment of a data management system 200 configured to store and manage data for processing price data for health services. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of healthcare claim data, lab data, physical test data, disease progression data, demographic data, geographic data, socioeconomic data, administrative data, clinical data, or the like. The customer information in each database may be keyed to a common field or identifier, such as a subject's name, social security number, customer number, or the like. Alternatively, the storage devices 204-208 may be arranged in a RAID configuration for storing redundant copies of the database or databases through either synchronous or asynchronous redundancy updates.

In one embodiment, the server 102 may submit a query to selected data storage devices 204-208 to collect a consolidated set of data elements for a subject or a group of subjects. The server 102 may store the consolidated data set in a consolidated data storage device 210. In such an embodiment, the server 102 may refer back to the consolidated data storage device 210 to obtain a set of data elements associated with a specified subject or subject group. Alternatively, the server 102 may query each of the data storage devices 204-208 independently or in a distributed query to obtain the set of data elements associated with a specified subject or subject group. In another alternative embodiment, multiple databases may be stored on a single consolidated data storage device 210.

In various embodiments, the server 102 may communicate with the data storage devices 204-210 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, the server 102 may communicate indirectly with the data storage devices 204-210; the server may first communicate with a storage server or storage controller 104.

In one example of the system 200, the first data storage device 204 may store data associated with clinical data that may be comprised in insurance claims made by one or more subjects. The clinical data may include data associated with medical services, procedures, and prescriptions utilized by the subjects. In one embodiment, the second data storage device 206 may store diagnosis data associated with the subject. The diagnosis data may include one or more diagnoses of conditions which the subject suffers from or is at risk of The third data storage device 208 may store lab test data associated with the subject. For example, the third data storage device 208 may include data associated with the subject's lab test results and/or clinical observations. A fourth data storage device (not shown) may store demographic data. For example, the demographic data may include information relating to the subject's demographics include gender, race or ethnicity, age, income, disabilities, mobility, educational attainment, home ownership, employment status, location, or the like.

The server 102 may host a software application configured for processing price data for health services. The software application may further include modules for interfacing with the data storage devices 204-210, interfacing a network 108, interfacing with a user, and the like. In a further embodiment, the server 102 may host an engine, application plug-in, or application programming interface (API). In another embodiment, the server 102 may host a web service or web accessible software application.

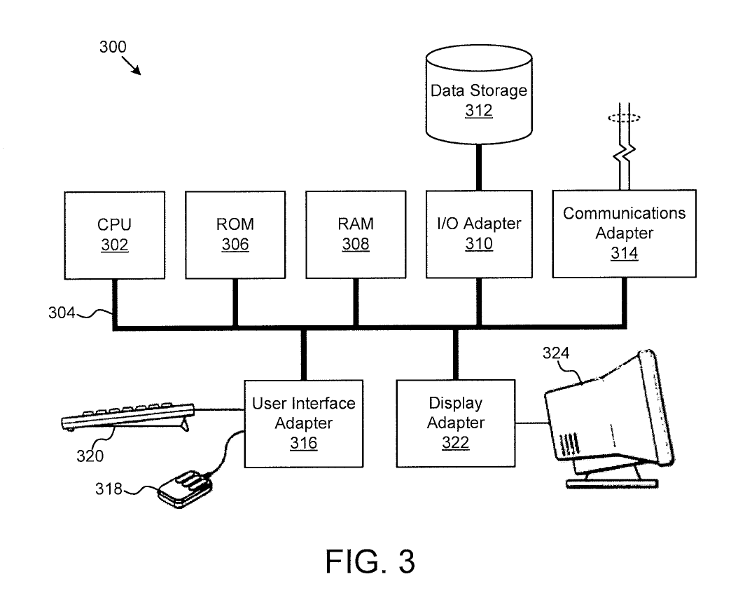

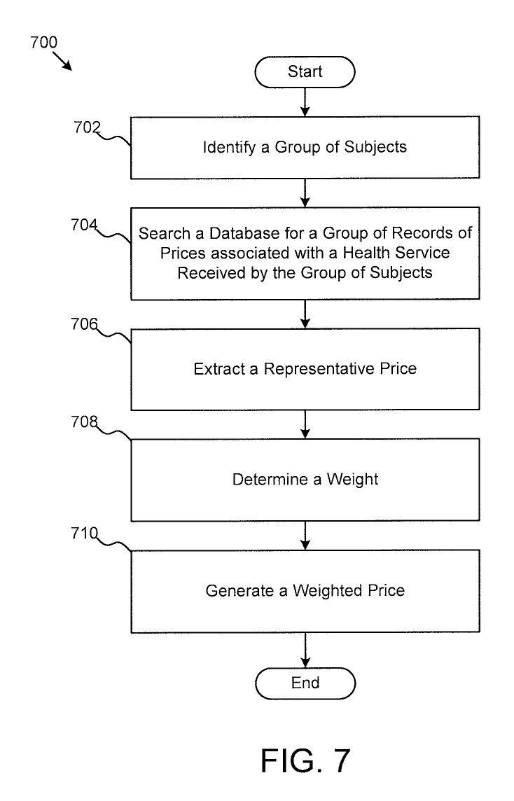

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU, a processor, or a microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIGS. 7-9.

The computer system 300 also may include Random Access Memory (RAM) 308, which may be SRAM, DRAM, SDRAM, or the like. The computer system 300 may utilize RAM 308 to store the various data structures used by a software application suitably programmed for processing price data for health services. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300 in order to input information for authenticating a user, identifying a subject or group, receiving health profile information, or entering information like a medical code, a test code, a temporal range, a percentile, a limiting criterion, or a selected test value range. In a further embodiment, the display adapter 322 may display a graphical user interface associated with a software or web-based application for generating an output comprising a graph of relative importance of prices or indices, or indices of different time frames.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 108, which may be one or more of a LAN and/or WAN, and/or the Internet. The user interface adapter 316 may couple user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

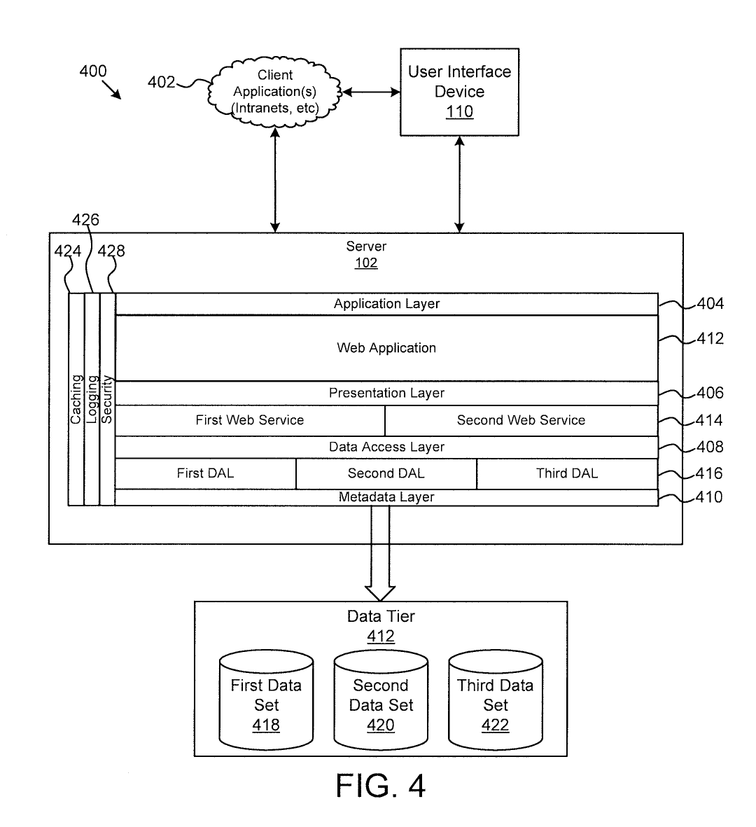

FIG. 4 illustrates one embodiment of a network-based system 400 for processing price data for health services. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 418-422 that comprise a data layer or data tier 412. For example, a first data set 418, a second data set 420 and a third data set 422 may comprise a data tier 412 that is stored on one or more data storage devices 204-208.

One or more web applications 412 may operate in the application layer 404. For example, a user may interact with the web application 412 though one or more interfaces 318 and 320 configured to interface with the web application 412 through an I/O adapter 310 that operates on the application layer. In one particular embodiment, a web application 412 may be provided for processing price data for health services that includes software modules configured to perform the steps of searching the database to obtain a group of records of prices for a health service received by a group of subjects, wherein the health service is comprised in a service category, extracting a representative price for the health service, determining a weight for the health service relative to the service category, and generating, using a processor, a weighted price based on the weight and the representative price.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation.

For example, a web application 412 for identifying price records and/or analyzing price data, or other information may access a first web service 414 for identifying price records of a first group of subjects receiving a first health service and a second web service 414 for identifying price records of a first group of subjects receiving a second health service. The web services 414 may receive predetermined criteria for selection of health services. In response, the web service 414 may return price data for subjects identified by one or more attributes to generate indices, statistics, distributions, graphs, or the like. One of ordinary skill in the art will recognize various web-based architectures employing web services 414 for modular operation of a web application 412.

In one embodiment, a web application 412 or a web service 414 may access one or more of the data sets 418-422 through the data access layer 408. In certain embodiments, the data access layer 408 may be divided into one or more independent data access layers (DALs) 416 for accessing subject data sets 418-422 in the data tier 412. These subject data access layers 416 may be referred to as data sockets or adapters. The data access layers 416 may utilize metadata from the metadata layer 410 to provide the web application 412 or the web service 414 with specific access to the data set 412.

For example, the data access layer 416 may include operations for performing a query of the data sets 418-422 to retrieve specific information for the web application 412 or the web service 414. In a more specific example, the data access layer 416 may include a query for records for subjects who have been identified by a demographic feature such as a Greater Los Angeles Metro area, and have received a service comprised in a service category, such as psychiatric hospital services.

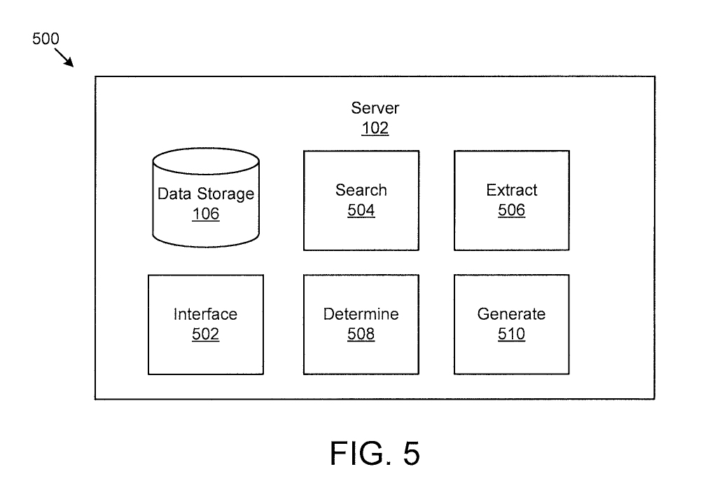

FIG. 5 illustrates a certain embodiment of a system 500 for processing price data for health services. In one embodiment, the system 500 comprises a data storage device 106 and a server 102 configured to load and operate software modules 504-510 configured for processing price data for health services. Alternatively, the system 500 may include hardware modules 504-510 configured with analog or digital logic, firmware executing FPGAs, or the like configured to obtain a group of records of prices for a health service received by a group of subjects, wherein the health service is comprised in a service category, extract a representative price for the health service, determine a weight for the health service relative to the service category, and generate, using a processor, a weighted price based on the weight and the representative price. In such embodiments, the system 500 may also include an interface 502, such as an I/O adapter 310, a communication adapter 314, a user interface adapter 316, a display adapter 322, or the like.

In one embodiment, the server 102 may include one or more software defined modules configured to search a dataset 418-422 on a data storage device 204-210 to obtain a group of records of prices for a health service received by a group of subjects, wherein the health service is comprised in a service category, extract a representative price for the health service, determine a weight for the health service relative to the service category, and generate, using a processor, a weighted price based on the weight and the representative price. In one embodiment, these modules may include an interface module 502, a search module 504, an extraction module 506, a determination module 508, and a generation module 510.

Generally, the interface module 502 may receive user inputs and display user outputs. For example, the interface module 502 may receive one or more attributes to identify a group of subjects. The interface module may further receive one or more predetermined criteria for health service selection, predetermined time frames, baseline time, and/or other user inputs. In a further embodiment, the interface module 502 may display weighted price, weights (relative importance), or indices. Such analysis results may include statistics, tables, charts, graphs, recommendations, and the like.

Structurally, the interface module 502 may include one or more of an I/O adapter 310, a communications adapter 314, a user interface adapter 316, and/or a display adapter 322. The interface module 502 may further include I/O ports, pins, pads, wires, busses, and the like for facilitating communications between the CPU 302 and the various adapters and interface components 310-324. The interface module may also include software defined components for interfacing with other software modules on the server 102.

In a specific embodiment, the server 102 may load and execute computer software configured to generate, retrieve, send, or otherwise operate SQL instructions. For example, the first search module 504 may communicate a first SQL query to the data storage device 106, which is configured to search the database for a group of records of price for a health service received by a group of subjects. A record may comprise a claim comprising price information associated with a subject and one or more services. The search may also involve a temporal component to aggregate records. If a record has a time aspect, the searches may obtain multiple records associated with the same subject, but identified by the same service at different time point within a common time frame. Those records may be processed, e.g., averaged, to yield a data value representing the time frame associated with the subject for receiving the same service. The price information of the records can be the amount assigned for purchasing, the amount paid, the amount billed, the amount used (cost), or the amount allowed. Such records can be in the form of claims or hospital records.

The price can also be adjusted by the units of the code in certain aspects. For example, a neurosurgery of the head is a much more complex surgery than a surgery of the foot. If the index collected the average price of surgeries, then these two types would have very different prices. Medicare publishes a schedule of relative value units (RVUs) for all CPT codes based on three factors physician work effort, practice price and malpractice insurance. Certain aspects of the present invention may use these RVUs per CPT code to compute the price per professional RVU: adjusted price(claim)=price(claim)/totalRVU (code of the claim). Prescription drugs may be described at the dosage and package level in the NDC codes so the price seen on the claim could be already a specific to these units.

In certain aspects, the search module 504 may be configured to search the database for a group of records of prices for a health service received by a group of subjects. Specifically, the search module 504 may generate a search query configured to retrieve for a group of records of prices matching a health service and a group of subjects identified by the same attribute. In a further embodiment, the group of records may include a temporal component, which may specify a time frame of a predetermined month, a quarter, a year or more.

By way of example, the search module 504 may identify a group of records for a group of subjects to provide facility fees for a specific service (e.g., CPT, LOINC, ICD9, or NDC code) and separately professional fees (e.g., CPT or ICD9 code) for the same codes in a predetermined calendar quarter. The group of subjects may be identified by a set of attributes, such as a predetermined combination of region, age, gender, condition, etc. The condition may be a health state, a specific disease state, or at risk or suspected to have a particular disease (a disease-related state). Cohort matching may be used to identify services that may be associated with a specific disease state or disease-related state. The identified services may then be used to search for records of the services.

In one embodiment, the extraction module 506 may extract a representative price for a specified service comprised in a service category, for example, an ICD9 code that belong to the service category “ER, professional fees.” In order to do so, the extraction module 506 may extract a geometric mean or an arithmetic mean from the group of records to represent a price for a service received by a group of subjects identified by a set of attributes.

In another embodiment, the determination module 508 may determine a weight for the health service relative to the service category, for example, by calculating a share of health service in this service category.

For price analysis of the service category, the generation module 510 may generate a weighted price for the health service based on the weight and the representative price determined by the extraction module 506 and the determination 508, respectively. The weighted price may reflect a price affected by the relative portion of the service relative to the service category.

For example, the extraction module 506, the determination module 508, or the generation module 510 may include analog or digital logic, firmware, or software configured to carry out one or more calculations according to one or more predefined logic functions. In a further embodiment, the server 102 may include a software defined extraction module 506, the determination module 508, or the generation module 510 configured to perform calculation of the information and data retrieved from the database for the group of records of prices.

In a specific embodiment, the search module 504 may feed retrieved data into a spreadsheet configured to perform one or more calculations on the data. For example an Excel® spreadsheet may include one or more embedded functions or operations configured to calculate statistics such as averages, ratios, counts, summations, and the like. The data may be automatically imported into a spreadsheet using a macro, a software-based script, or the like. In an alternative embodiment, the extraction module 506, the determination module 508, or the generation module 510 may include hard-coded or dynamically variable software functions for calculating such statistics and generating results for a user. In a further embodiment, the generation module 510 may also create outputs such as statistics, tables, charts, graphs, recommendations, and the like, and particularly generate a weighted price for the health service based on the weight and the representative price.

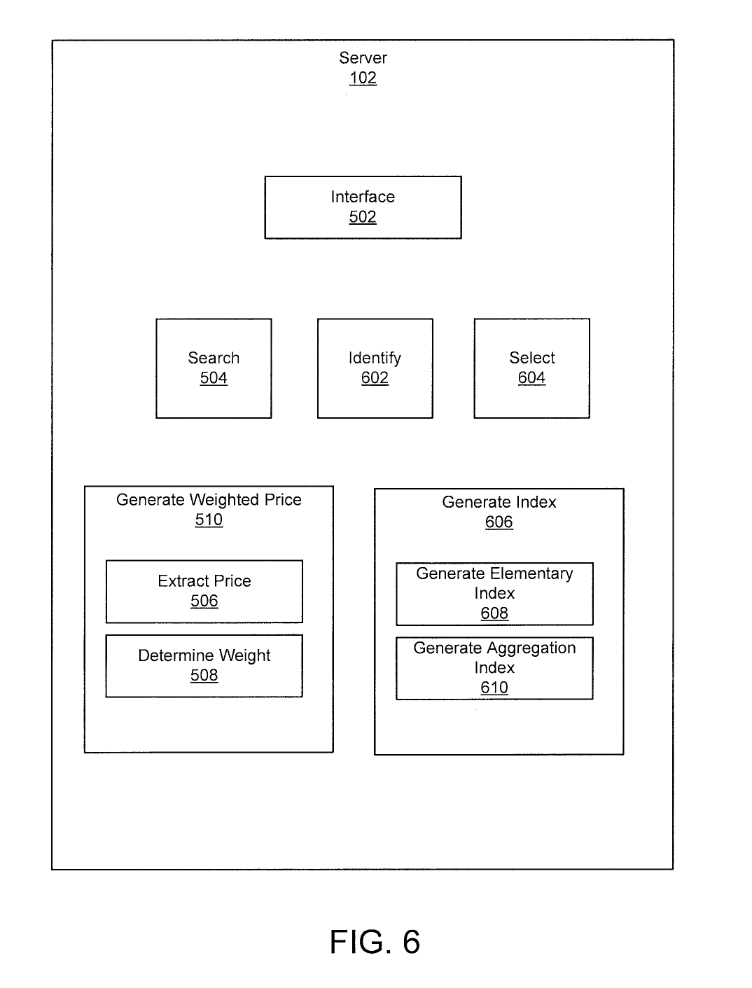

FIG. 6 illustrates a further embodiment of a system 500 for processing price data for health services. The system 500 may include a server 102 as described in FIG. 5. In a further embodiment, the server 102 may include additional software defined modules. For example, the server 102 may include an identification module 602 and a selection module 604. In addition to the extraction module 506, the determination module 508, and the weighted price generation module 510, the server 102 may further comprise an index generation module 606 comprising a generation module 608 for elementary index and a generation module 610 for aggregation index.

In a certain embodiment, the identification module 602 may identify a group of subjects with one or more attributes such as a medical condition, a demographic feature, a geographical feature, or a combination thereof. Specific attributes may include, but not be limited to, region of the country, such as states, zip codes, or any non-overlapping area; gender; age, such as non-overlapping buckets of years 0-2, 3-6, 7-18, 19-34, 35-64, 65-75, and older; medical condition, such as diabetes, coronary artery disease, hypertension, hyperlipidemia, etc. The geography feature used for partitioning could include one or more members from the Combined Statistical Areas (Census defined, 123 areas, http://en.wikipedia.org/wiki/ Table_of_United_States_Combined_Statistical_Areas), or could also include members from CBSA (Core Based Statistical Area), preferably with about or more than 1 million population that are not CSAs (e.g., Miami, Portland, Phoenix, San Diego, Tampa, Va Beach, Austin, Jacksonville, Memphis, Richmond). In a certain embodiment, such an attributes may be a set of conditions and features, for example, a combination of geographical feature, sex, age, and conditions, such as {Florida, Males, 35-64 years old, with Diabetes}.

In an additional embodiment, the selection module 604 may select the service by predetermined criteria for being comprised in a service category. The predetermined criteria could be a specific procedure code (e.g., coded as CPT—Current Procedural Terminology), a prescription drug (e.g., coded using NDC—national drug code), or a lab test (e.g., coded as LOINC values—Logical Observations Identifiers, Names, Codes). In a further embodiment, the selection module 604 may select a upper level service category for a group of subject of interest, and then define a basket of most common medical services, or best practices as a variety of service categories comprised in the upper level service category. The specific codes that are used in those services may be selected by the selection module 604 as a selected service.

In certain embodiments, the selection module 604 may select the service based on a hierarchy of health services, which may be defined by grouping related services into sets of services that are useful to health plan managers and health policy planners. The selection module 604 may use the grouping criteria to select certain service(s) for generating weighted prices or indices for a service category. The grouping criteria for defining service categories may include locations of service—Inpatient (IP), Outpatient (OP), Office, Emergency Room (ER), Other, N/A; type of service—Professional, Facility, Other; a set of related codes, for example, NDC codes used for prescription drugs in claims may be mapped into therapeutic classes, the set of CPT codes may be grouped into levels as defined by the AMA (American Medical Association) in the CPT Developers Toolkit, or claim data could be mapped to a clinical ontology like SNOMED CT (Systematized Nomenclature of Medicine—Clinical Terms) for the purpose of aggregating similar claims by medical use. Other partitions of the claims may be used reduce the variance of the resulting weighted prices or index values. For example, top level categories could use locations of service (IP, OP, ER, Misc.), and the next level could be to separate professional fees from facility fees.

In another embodiment, the selection module 604 may select price records on the services wherein each of the services is related to a specific condition associated with a group of subjects. This may reduce variance and allow to generate condition-specific weighted prices or indices of a generic basket of services.

The selection module 604 may also select health services based on the following categories published by BCBS in the Medical Price Reference Guide (using data from CMS): Hospital Care, Physician and Clinical Services, Prescription Drugs, Nursing Home and Home Health, Other Spending. Note that Hospital Care is not just facility charges, but all in-patient charges see world web via cros.hhs.gov/NationalHealthExpendData/downloads/quickref.pdf for the definitions.

In a further embodiment, the generation module 510 for weighted price may include the extraction module 506 and the determination module 508 to generate a weighted price for a specified service relative to a service category as described above.

In a still further embodiment, the index generation module 606 may be used to further analyze services and populations for the price information. The index may need three basic pieces of information—a set of health services selected by the selection module 604, a representative price for each service in the current and base time periods extracted by the extraction module 506, and a weight for each service indicating its importance to the total determined by the determination module 508. With this information a price index can be generated by the index generation module 606.

In a certain embodiment, there may also be a design of the structure of the index by the index generation module 606. The indices generated may include multiple levels of indices such as from the “all services,” “all cities,” “all services” at each city, “all services except a specific service category,” and also the more detailed indices in terms of demographics (regions, age, condition, etc.) and services (inpatient, outpatient, ER, Rx, etc.) The most detailed level of the index is an “elementary index” as not being combined with other indices and determined by the elementary index generation module 608.

In a particular embodiment, the index generation module 606 may select a set of services, S, that may be completely described by specifying the location, type, and code set. For example:
Label all RX prices with location=N/A, type=other, code=therapeutic class
Outpatient, Professional, Radiology Services
Inpatient, Facility, Oncology Services
Outpatient, Professional, Tissue Biopsies

In a preferred embodiment, the service is a subject such as a patient receives that can only appear in one element of S otherwise the method could double count some services. A specific CPT code may appear in different settings for its use in inpatient or outpatient services, but the set of services must unambiguously assign a record such as claim to one element of S.

If e is an elementary index and A is the set of elementary indices that form an aggregate index, AI, then the index value of AI at time t, IX(AI,t) is

$$IX ( AI , t ) = {\sum }_{e ∈ A} IX ( e , t ) \cdot ω ( e , t 0 )$$

$$where ω ( e , t 0 ) = \frac{cost ( e , t 0 )}{{\sum }_{f ∈ A} cost ( f , t 0 )}$$

and cost(e, t0) is the total cost of all the items that make up the elementary index e and t0 is the baseline time period.

An elementary index, e, could be the time neutral value of a set medical prices experienced by a set of people with common features, wherein the common features of the set of people in e may be their demographics, d.

The set of all elementary indices generated by the index generation module 608 may be the Cartesian product of S and D, e=(s,d).

In a certain embodiment, the index generation module 606 determines the definition of s to stipulate the codes that are found in this set of medical services. This list of codes allows to filter the universe of all claims in a time period t to the claims paid in time period t for a group of subjects who have the features of d and had services in s. This filtered set of claims is the set of claims that will define the prices for this elementary index, e. This filtered set of claims in period t is Cl(s,d,t).

In certain aspects, all codes defined in s may be used as described above or for computational reasons the defined codes of s may be restricted to a working set or a representative set of codes which may depend on the time period. For example, if there are 1000 NDC codes for prescription drugs in s it may be beneficial to limit these to the codes that constitute 80% of the total price either by taking the codes with the largest percentage price of s, or by sampling codes at random without replacement from s until the 80% price threshold is reached.

For example, the elementary index generation module 606 may compute the total price of all the claims in elementary index e at any time t:

$$cost ( e , t ) = {\sum }_{{c ∈ Cl ( s , d , t )}_{e = ( s , d )}} price ( c )$$

The representative price of a specific code (regardless if its CPT, NDC, etc) in e could be the mean of that one code's price for all the claims in Cl(s,d,t) as determined by the extraction module 506. This mean may be the arithmetic or geometric mean of these amounts.

$$\overline{p} ( code , e , t ) = \frac{{\sum }_{{clm ∈ Cl ( s , d , t )}_{{code ∈ clm}_{e = ( s , d )}}} price ( clm )}{\vert clm ∈ Cl ( s , d , t ) \& code ∈ clm \vert}$$

$$or$$

$$\overline{p} ( code , e , t ) = {( {\prod }_{{clm ∈ Cl ( s , d , t )}_{{code ∈ clm}_{e = ( s , d )}}} price ( clm ) )}^{\frac{1}{\vert clm ∈ Cl ( s , d , t ) \& code ∈ clm \vert}}$$

From the mean price of each specific code in e the determination module 508 computes the weighted mean price of e with weights equal to the fraction of total price contributed by that code.

$$\overline{p} ( e , t ) = {\sum }_{code ∈ e} \overline{p} ( code , e , t ) \cdot {\sum }_{{clm ∈ Cl ( s , d , t )}_{{code ∈ clm}_{e = ( s , d )}}} price ( clm ) / cost ( e , t )$$

Alternately the relative weights can be the same weights from t0, not the current quarter.

$$\overline{p} ( e , t ) = {\sum }_{code ∈ e} \overline{p} ( code , e , t ) \cdot {\sum }_{{clm ∈ Cl ( s , d , t 0 )}_{{code ∈ clm}_{e = ( s , d )}}} price ( clm ) / cost ( e , t 0 )$$

The elementary index generation module 608 may determine the index value for an elementary index IX(e,t) so that IX(e,t0)≡100 and then

$$IX ( e , t ) = {\prod }_{code ∈ e} {( \frac{\overline{p} ( code , e , t )}{\overline{p} ( code , t - 1 )} )}^{\frac{{\sum }_{{clm ∈ Cl ( s , d , 0 )}_{{code ∈ clm}_{e = ( s , d )}}} price ( clm )}{cost ( e , t 0 )}}$$

In a further embodiment, the aggregation index generation module 610 can create an aggregate index, agg, from two or more elementary indices. Thus, if E is the set of all elementary indices (the Cartesian product of the service set and demographic set S*D), then agg [symbol] E. The total price of all codes in agg in time period t is:

$$cost ( agg , t ) = {\sum }_{e ∈ agg} cost ( e , t ) .$$

The relative importance of elementary index e in agg is the ratio price(e,t)/price(agg,t). The value of the index agg at time t is then:

$$IX ( agg , t ) = \frac{{\sum }_{e ∈ agg} IX ( e , t ) \cdot cost ( e , t )}{cost ( agg , t )}$$

Although the various functions of the server 102 and the CPU or processor 302 are described in the context of modules, the methods, processes, and software described herein are not limited to a modular structure. Rather, some or all of the functions described in relation to the modules of FIGS. 5-6 may be implemented in various formats including, but not limited to, a single set of integrated instructions, commands, code, queries, etc. In one embodiment, the functions may be implemented in database query instructions, including SQL, PLSQL, or the like. Alternatively, the functions may be implemented in software coded in C, C++, C#, php, Java, or the like. In still another embodiment, the functions may be implemented in web based instructions, including HTML, XML, etc.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 7 illustrates one embodiment of a method 700 for processing price data for health services. In one embodiment, the method 700 starts when the identification module 602 identifies 702 a group of subjects. The method 700 may continue when the server 102 issues a command to search 704 a database stored on the data storage device 106 for a group of records. The group of records may be prices for a health service received by the group of subjects. For example, the server 102 may send an SQL query to the database to retrieve healthcare records associated with subjects sharing one or more attributes such as a set of demographic and geographic features, as well as conditions, e.g., a group of diabetic patients in an age group 35-64 in a specified metro area.

The server 102 may then issue a command to extract 706 a representative price for a health service received by the group of subjects. For example, the representative price may be an arithmetic or geometric mean price of a specific service relative to a service category, such as an X-ray service belonging to a radiology service category. In certain aspects, the price records may be trimmed out top and bottom 5% if the service is considered in a national scale. Specific service providers may also be chosen for filtering the records to extract a representative price.

Further, the server 102 may determine 708 a weight for the service relative to the service category. For example, the weight may be determined by computing the contribution of the service to the total price of the service category in the benchmark year (the market share of money spent on this service for this elementary index). This estimate may have some variance. To reduce variance, several techniques may be used. For example, the benchmark year may be extended to multiple years. In certain aspects, a combined weight may be determined, for example, by averaging the importance of a specific metro area together with other areas in that region, or an age group with its neighboring age groups. Depending on the selection of the type of price index, the relative importance (weight) of the services can be static relative to the benchmark year or changing over time. In a still further aspect, the processor 302 may generate 710 a weighted price for the service as described above.

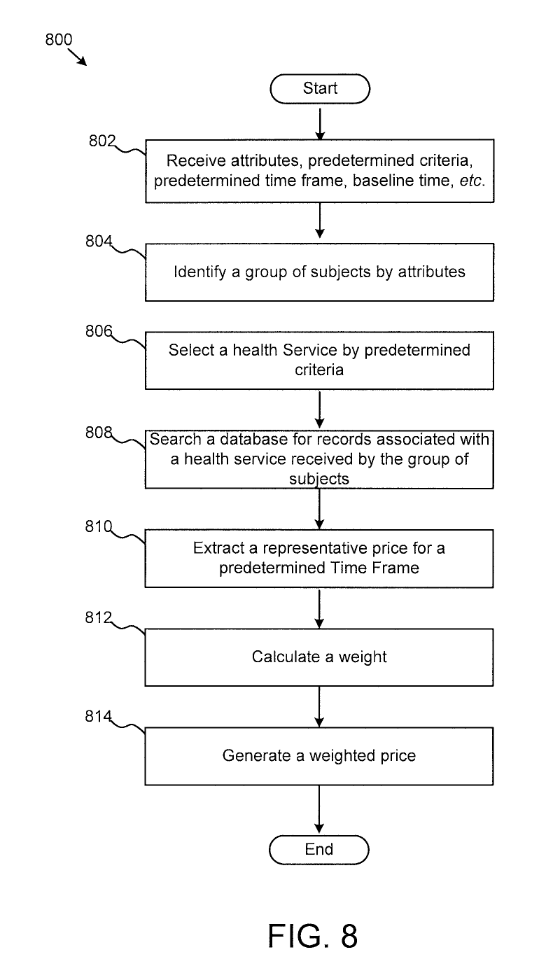

FIG. 8 illustrates another embodiment of a method 800 for processing price data for health services. In one embodiment, the method 800 starts when the interface module 502 receives 802 limiting criteria including one or more attributes for identifying subjects, predetermined criteria for selecting services, a predetermined time frame for filtering of records, a baseline time for adjusting indices, etc. For example, the interface module 502 may include a graphical user interface. The interface module 502 may receive user inputs consisting of identifiers or indicants of the attributes, criteria or time. The server 102 may then identify 804 a group of subjects by attributes, such as a selection of a value, e.g., an ICD-9 code value, an age value, a gender value, a location, or a set thereof. The server 102 may also select 806 a health service by predetermined criteria such as a specific CPT code. The search module 504 may search a database for records of prices for the health service received by the group of subjects.

In certain aspects, a predetermined time frame may include window values configured to limit or restrict the time frames to a baseline period or to a current period. The server 102 may incorporate the limiting criterion into a query used to filter the records by the limiting criterion before, during or after the search 808. For example, the query may search for all records associated with subjects that have been diagnosed with diabetes in a specified metro area, but the query may be restricted to return only results of the most recent two years in the database. In a further embodiment, the sever 102 may extract 810 a representative price for a predetermined time frame, calculate 812 a weight, and generate 814 a weighted price relative to the service category.

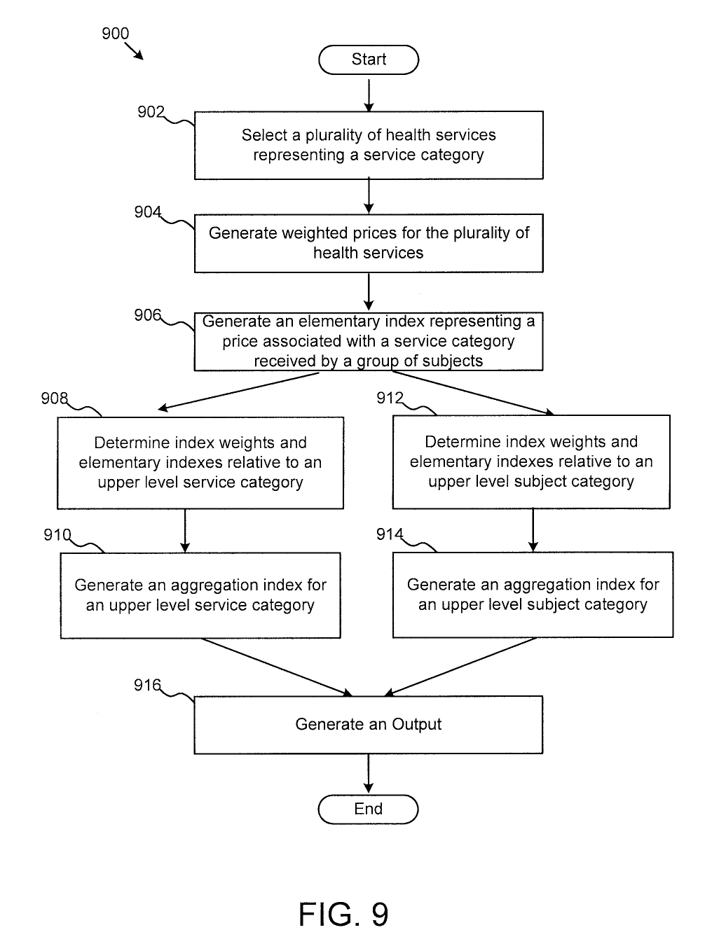

FIG. 9 illustrates another embodiment of a method 900 for processing price data for health services. In one embodiment, the method 900 starts when the selection module 604 selects 902 a plurality of services representing a service category, for example, for creating an elementary index to represent a price for the service category. The set of services in an elementary index may be the same across all demographics, but the lower level services that go into the service category may differ by demographics. For example, if “ER, Professional Fees” is the service category, then the exact ICD9 codes that appear in this service Los Angeles will differ from the codes that appear in the same service in Des Moines. The codes that appear in the service are sampled from the demographic group. In certain aspects special services may be chose for specific conditions. For example, the server 102 may select the services that go into EBM Connect compliance scores and index the price of 100% compliance at a specific date. This would be a “price of best practice” for a condition, rather than a price of the services people actually consumed.

To provides a list of services (a basket) representing a service category for the elementary index a statistical sampling approach may be used, such as frequency sampling or significance sample. An exemplary method may have the following steps: list all services at their lowest level of detail by frequency count; determine the correct sample size, then systematically sample according to the computed step size through the list of services. This approach has two main benefits. First, the codes are not the same in two different demographics. This provides flexibility so there will be no concerns about prostate codes appearing from women. It also allows flexibility over time. A specific code will not be tracked at the price of more variance. An alternative is to define the services for each demographics at time 0, then track these over many years and update these codes.

In certain aspects, the services selected to represent a service category may be changed over time. For example, a specific service may not be available, while the CPT codes may replace it by adding in new more specific codes. In this case the set of new codes may be treated as the old code. If an NDC code is no longer available then a suitable replacement may be sought with similar effect (note generics share the same NDC code as their branded drugs). Clinical guidance may be considered in these aspects.

In a further embodiment, new services may be introduced in the service category. The entire process may be repeated using the statistical sampling approach described above to select a new set of representative services. For example, select 10% of the services to be replaced; create the complete frequency count of all services as was done for the initial determination of the basket; fake sampling without replacement for the 90% of items that remain and continue to actually sample without replacement for the 10% needed. Drugs and labs may need a separate update schedule from other services (every 6 months or annually) to allow new drugs to be incorporated more rapidly into the index.

In a certain embodiment, the server 102 may generate 904 weighted prices for each of the plurality of health services by the steps described in FIGS. 7-8. The elementary index generation module may generate 906 an elementary index representing price for a service category received by the same group of subjects.

The set of elementary indices may stratify the services by all the dimensions that add significant value to the price of the index and also that reduce the variability within the set members. For example, certain aspects of the invention may generate the elementary index (including relative importance and average price) for Greater Los Angeles Metro Area, Psychiatric Hospital Services. These details may allows consultants and customers to create custom indices, Greater LA Metro Area Hospital Services minus Psychiatric Hospitals and All Cities, Psychiatric Hospital Services. In general, a custom index can be created by dropping a set of elements and re-computing weights (new weight w′(i)=w(i)/sum(j)w(j)).

It may need to be careful to not over-specify the detailed level of data provided. The more detailed the elementary index, the less data in each cell (a specific service-subject combination at the most basic level). Different indices may also need different frames, though this will increase the price of providing the indices.

The set of elementary indices has two classes of stratification—demographics (region, age, gender, condition, etc.) and services (in-patient, out-patient, ER, RX, etc.) These two groups of sets will be referred to as subject groups and services. An elementary index can be identified by enumerating elements of the Cartesian product of the subject group attributes and one service.

The server 102 may then determine 908 index weights and elementary indices for each of a plurality of service categories, wherein the service categories are comprised in an upper level service category, such as all the in-patient services, and generate 910 an aggregation index representing a price of the upper level service category. In an alternative embodiment, the server 102 may determine 912 index weights and elementary indices for each of a plurality of subject categories, wherein the subject categories are comprised in an upper level subject category, such as all subjects from the metro areas comprised in a particular state, and generate 910 an aggregation index representing a price of the upper level subject category—the state. For example, the weighted prices across different populations of subjects may be aggregated into an aggregation index. Steps 908-910 and steps 912-914 may be combined to generate an aggregation index for any levels of aggregation indices with a specific combination of subject groups and service categories. In certain aspects, the weighted price or indices may be a relative price or index as compared to a baseline time, such as an initial year.

Once the elementary index values are computed for all services and demographics, then they may also be combined into a single national index. This may need to consider the changes in the relative importance of each service in each cell. The effect of changing these weights “inside” the elementary indices needs to be accounted for in creating any aggregate of elementary indices.

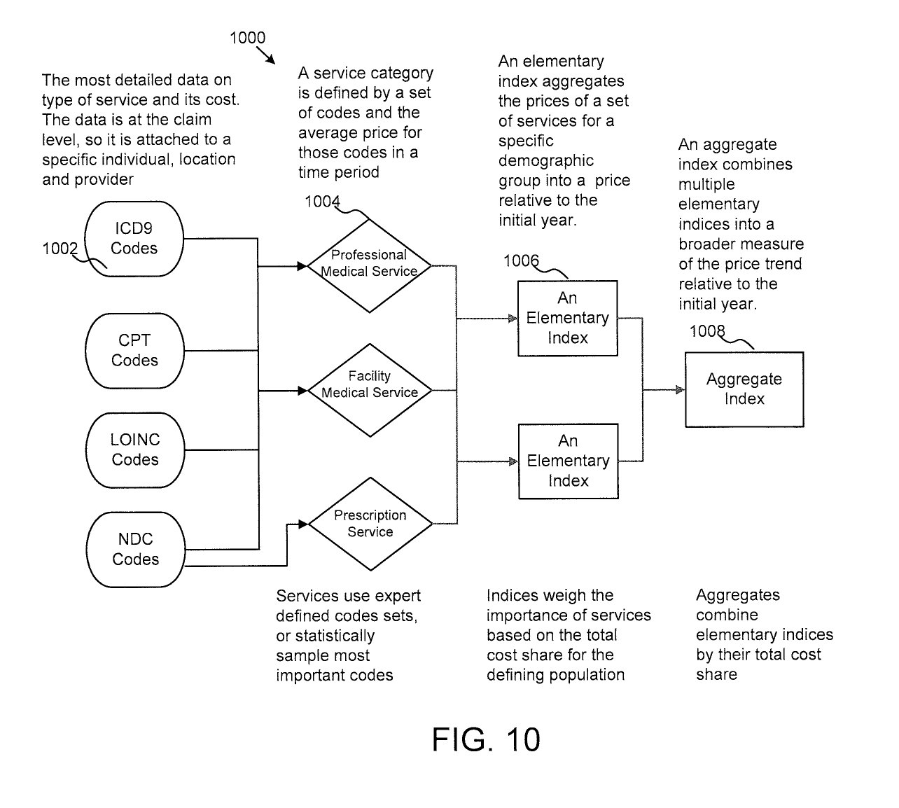

FIG. 10 illustrates an embodiment of a method 1000 for processing price data for health services. Representative services 1002 may be selected using expert defined code sets, or a set of the most important codes obtained by statically sampling, such as a set of ICD9 codes, CPT codes, LOINC codes, NDC codes, the like, or a combination thereof. Basic level data can be obtained based on the type of service represented by the selected services and their prices. These data may be claims, and may be attached to specific individuals (i.e., subjects), location, provider, and specific services. The service category 1004 relative to the basic level service specified by a particular code, may be defined by a set of selected codes and the average price for those codes in a time period. The service category 1004 may include professional medical services, facility medical services, prescription service, or the like. The average price and weight of each particular code relative to the service category may be determined to generate a weighted price. The weighted prices of these code sets may be processed to generate an elementary index 1006 by aggregating the prices of a set of service codes for a specific demographic group into a price relative to the initial year. Indices weight the relative importance of service or code sets based on the total price share for the defining population, i.e., the identified group of subjects. A plurality of elementary indices may be combined to generate an aggregation index 1008 as a broader measure of the price relative to the initial year by their total price share.

In certain aspects, the price indices generated may be traded on the Lewin Exchange. Customers may get advanced indication of price changes. Volatility in price indices may indicate areas of increased risk.

The quality of the index may be affected by three factors: the variance of the prices in the elementary indices, p̅; the volume of people and claims in the demographic set d; changes in the claims stream that arise from new sources of claims over time. For example, a new employer joins the data service and that new employer now is more than 50% of the population in some demographic sets or a similarly size employer exits the data service. Mitigating the detrimental effects, and maximizing the beneficial aspects of these factors is important.

Because the prices of p̅ are calculated from claims data, there are many sources of variation embedded in the distribution of p̅. Certain aspects of the invention use variance reduction methods of p̅, which may allow for standard statistical techniques to be applied to improving the estimate of p̅. These include but are not limited to:
Removing outliers
Applying the techniques found in survey analysis to improve p̅. The claims data stream used can be viewed as the survey responses submitted from a larger population of unknown claims. See Wolter, K. (1985). Introduction to variance estimation, New York: Springer-Verlag.
Specific code tracking. Another way to reduce the variance of p̅ is to track a smaller set of specific codes from quarter to quarter, rather than compute p̅ using all codes in the set. While the larger sample size from including all codes will reduce variance to some extent, there may be more variance from blending the prices of dissimilar procedures together.

The variance may be reduced by specific code tracking in p̅, for example, limiting the codes that contribute to the value p̅, then certain aspects of the invention may choose which codes to use and have a strategy for evolving (adding new, and replacing old) codes over time.

Methods for choosing the codes to track include:
Choose those codes responsible for at least 80% of the price at t0.
Choose those codes responsible for at least 80% of the price in the entire year before t0.
Choose the number of codes, n, such that the probability of detecting a 1% change in price 95% of the time. The value of n can be computed using the Central Limit Theorem of Lyapunov, a generalization of the usual Central Limit Theorem, which allows non identically distributed random variables. See for example: world wide web via.itl.nist.gov/div898/handbook/ppc/section3/ppc333.htm

New drugs and new medical procedures are introduced to the market all the time. The Index needs to evolve to capture these new services. The index does not wish to re-compute all the codes each quarter, because that would defeat the purpose of tracking codes as long as possible.
Determine any “dead” codes. If any regulatory body has retired a code that is currently one of the tracking codes, then that tracking code must be removed.
   If the retired code is replaced with a new code, or code set, then add the new codes to the index in place of the retired code. Adjust the price of the new codes by multiplying by the ratio of the old RVU/new RVU. The RVU's are published by CMS.
   If no replacement code is available, then treat the removed code as if it were randomly selected for removal.
If a code is not retired, but is not found in this quarter's data, then mark it as missing.
   Compute the index value for this quarter by removing the market share of this code from price(e,t0).
If less than 10% of the codes in the tracking set are retired, then select a random set of codes without replacement so the total number of codes both retired and selected is the smallest possible number greater or equal to 10%. Remove these codes from the tracking set.
The tracking set now contains 90% of the codes from the previous quarter. The 10% of codes to be added are sampled without replacement from the set of all codes minus the ones already in the tracking set. The probability of selecting a single code in this step should be proportional to the market share of that code in the remaining set of codes. Each code selected at this step is now added to the tracking set.

The price records may also have changes in demographics over time. For example, the claim stream may change over time much like a survey replicated over multiple years will have responses from an evolving set of people. Certain aspects of the invention can take advantage of analytical techniques from the survey field to have the claim stream at time t reflect the composition of the claim stream at time t0. These techniques include:
Sampling weights—adjusting the weight of any one claim by the frequency at which claims like this are found in the total population.
Raking methods similar to Generalized Raking Procedures in Survey Sampling, by Jean-Claude Deville, Carl-Erik Sarndal and Olivier Sautory, Journal of the American Statistical Association, Vol. 88, No. 423 (September, 1993), pp. 1013-1020

In certain aspects, the invention may be embedded in a web service, such as the Employer Web product, to enable users like employers to understand their health care treads and how to make changes to drive lower-price, higher-quality healthcare decisions. Certain embodiments of the invention may also help new markets (ventral capitalists and financial analysts) in valuations of companies and investment options.

In some further embodiments, the methods and systems for indices generation may be combined with simulation methods to indicate areas where prices exceed norms and craft strategies to address the gaps versus the norms. For example, the combined methods may answer questions like: if 5% more employees were highly active, then what is the projected change in PMPM (Per Member Per Month)? If 10% of diabetics changed their BMI to levels below 25, then what is the projected change in PMPM? To answer this kind of questions, the database may comprise records for simulation, e.g., hypothetical price records simulated for the predefined changes. In addition, the consultants may work with clients on strategies to enact these changes.

All of the methods disclosed and claimed herein can be made and executed without undue experimentation in light of the present disclosure. While the systems and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

### REFERENCES

The following references, to the extent that they provide exemplary procedural or other details supplementary to those set forth herein, are specifically incorporated herein by reference.
BLS, Handbook of Methods, Chapter 17, page 2, world wide web via bls.gov/opub/hom/pdf/homch17.pdf
Jean-Claude Deville, Carl-Erik Sarndal and Olivier Sautory, Journal of the American Statistical Association, Vol. 88, No. 423 (September, 1993), pp. 1013-1020
Wolter, K. (1985). Introduction to variance estimation, New York: Springer-Verlag.

What is claimed is:

1. A method comprising:
searching a database stored on a data storage device to obtain a group of records of prices for a health service received by a group of subjects, wherein the health service is comprised in a service category;
extracting a representative price for the health service;
determining a weight for the health service relative to the service category; and
generating, using a processor, a weighted price for the health service based on the weight and the representative price.

2. The method of claim 1, wherein the group of subjects are identified by one or more attributes selected from the group consisting of a medical condition, a demographic feature and a geographical feature.

3. The method of claim 1, wherein the health service is selected by predetermined criteria.

4. The method of claim 1, wherein the health service is selected from the group consisting of a procedure, a prescription drug, and a lab test.

5. The method of claim 1, wherein the representative price is extracted for a predetermined time frame.

6. The method of claim 1, wherein the weight of the health service is calculated as the ratio of the total prices for the service to the total prices for the service category.

7. The method of claim 1, further comprising:
deriving an elementary index representing a price of the service category from weighted prices of a plurality of health services.

8. The method of claim 7, wherein the elementary index represents a price change relative to a baseline time.

9. The method of claim 7, further comprising:
determining index weights and elementary indices for each of a plurality of service categories, wherein the plurality of service categories are comprised in an upper level service category; and
generating, using a processor, an aggregation index based on the index weights and the elementary indices, wherein the aggregation index represents a price of the upper level service category.

10. The method of claim 7, further comprising:
determining index weights and elementary indices for each of a plurality of subject groups, wherein the plurality of subject groups are comprised in an upper level subject category; and
generating, using a processor, an aggregation index based on the index weights and the elementary indices, wherein the aggregation index represents a price of the upper level subject category.

11. A system comprising:
a data storage device configured to store a database comprising one or more records;
a server in data communication with the data storage device, suitably programmed to:
search the database to obtain a group of records of prices for a health service received by a group of subjects, wherein the health service is comprised in a service category;
extract a representative price for the health service;
determine a weight for the health service relative to the service category; and
generate a weighted price for the health service based on the weight and the representative price.

12. The system of claim 11, wherein the group of subjects are identified by one or more attributes selected from the group consisting of a medical condition, a demographic feature and a geographical feature.

13. The system of claim 11, wherein the health service is selected by predetermined criteria.

14. The system of claim 11, wherein the health service is selected from the group consisting of a procedure, a prescription drug, and a lab test.

15. The system of claim 11, wherein the representative price is extracted for a predetermined time frame.

16. The system of claim 11, wherein the weight of the health service is calculated as the ratio of the total prices for the service to the total prices for the service category.

17. The system of claim 11, wherein the server is suitably programmed to further:
derive an elementary index representing a price of the service category from weighted prices of a plurality of health services.

18. The system of claim 17, wherein the elementary index represents a price change relative to a baseline time.

19. The system of claim 17, wherein the server is suitably programmed to further:
determine index weights and elementary indices for each of a plurality of service categories, wherein the plurality of service categories are comprised in an upper level service category; and
generate an aggregation index based on the index weights and the elementary indices, wherein the aggregation index represents a price of the upper level service category.

20. The system of claim 17, wherein the server is suitably programmed to further:
determine index weights and elementary indices for each of a plurality of subject groups, wherein the plurality of service categories are comprised in an upper level subject category; and
generate an aggregation index based on the index weights and the elementary indices, wherein the aggregation index represents a price of the upper level subject category.

21. A tangible computer program product comprising a computer readable medium having computer usable program code executable to perform operations comprising:
searching a database stored on a data storage device to obtain a group of records of prices for a health service received by a group of subjects, wherein the health service is comprised in a service category;
extracting a representative price for the health service;
determining a weight for the health service relative to the service category; and
generating a weighted price for the health service based on the weight and the representative price.

22. The tangible computer program product of claim 21, wherein the group of subjects are identified by one or more attributes selected from the group consisting of a medical condition, a demographic feature and a geographical feature.

23. The tangible computer program product of claim 21, wherein the health service is selected by predetermined criteria.

24. The tangible computer program product of claim 21, wherein the health service is selected from the group consisting of a procedure, a prescription drug, and a lab test.

25. The tangible computer program product of claim 21, wherein the representative price is extracted for a predetermined time frame.

26. The tangible computer program product of claim 21, wherein the weight of the health service is calculated as the ratio of the total prices for the service to the total prices for the service category.

27. The tangible computer program product of claim 21, wherein the operations further comprise deriving an elementary index representing a price of the service category from weighted prices of a plurality of health services.

28. The tangible computer program product of claim 27, wherein the elementary index represents a price change relative to a baseline time.

29. The tangible computer program product of claim 27, wherein the operations further comprises:
determining index weights and elementary indices for each of a plurality of service categories, wherein the plurality of service categories are comprised in an upper level service category; and
generating an aggregation index based on the index weights and the elementary indices, wherein the aggregation index represents a price of the upper level service category.

30. The tangible computer program product of claim 27, wherein the operations further comprises:
determining index weights and elementary indices for each of a plurality of subject groups, wherein the plurality of subject groups are comprised in an upper level subject category; and
generating an aggregation index based on the index weights and the elementary indices, wherein the aggregation index represents a price of the upper level subject category.
